(19) United States
(12) Patent Application Publication
(10) Pub. No.: US 2003/0200962 A1
(43) Pub. Date: Oct. 30, 2003

(54) Portable barbeque assembly

(76) Inventor: Larry L. Pruett, Saint Charles, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/135,093

(22) Filed: Apr. 30, 2002

(51) Int. Cl. F24C 1/16; A47J 37/00

(52) U.S. Cl. 126/276; 126/25 R

(57) ABSTRACT

The present disclosure provides a barbeque grill including a vehicle front-end assembly defining a barbeque pit compartment and a barbeque pit mounted within the barbeque pit compartment.

### FIELD OF THE INVENTION

The field of the invention generally relates to barbeque grills. More specifically, the invention relates to a towable barbeque grill fabricated from a portion of a vehicle.

### BACKGROUND OF THE INVENTION

According to the Barbeque Industry Association, three out of four American homes own one or more barbeque grills. Many barbeque grills are small and easily moved from place to place and accommodate only enough food for small groups. Larger grills can accommodate larger groups, but are more difficult to transport to events away from home, such as large picnics or special events such as auto races, county fairs, sporting event “tailgating” events or other such gatherings.

Additionally, it is well known that Americans have a love for automobiles and that most Americans own a car. Particularly, a large segment of the American population enjoys classic autos. Cars also provide many amenities that Americans enjoy, such as a radio or recorded music player and comfortable seats that are not found with barbeque grills. Particularly since outdoor barbeques normally take place in a party-type environment, the radio and/or recorded music player is particularly desirable for use in conjunction with a barbeque grill. Cars also include headlights and power supplies, which may used to illuminate the surrounding area. Finally, many barbeques involve the consumption of cold beverages, as barbequeing normally takes places in warm weather. As a result, it would be desirable to provide for the dispensation and cooling of beverages for barbequers and their guests to enjoy. Therefore, given the popularity of both barbeque grills and automobiles, there is a need for a device that satisfies America's need for barbeque grills and its love of automobiles.

### SUMMARY OF THE INVENTION

The present invention comprises a barbeque grill comprising a vehicle front-end assembly defining a barbeque pit compartment and a barbeque pit mounted within the barbeque pit compartment.

### BRIEF DESCRIPTION OF THE DRAWINGS

FIG. 1 is a side view of the preferred embodiment of the present invention;

FIG. 2 is an overhead view of the preferred embodiment of the present invention; and

FIG. 3 is a front view of the dash of the preferred embodiment of the present invention.

### DETAIL DESCRIPTION OF THE PREFERRED EMBODIMENT

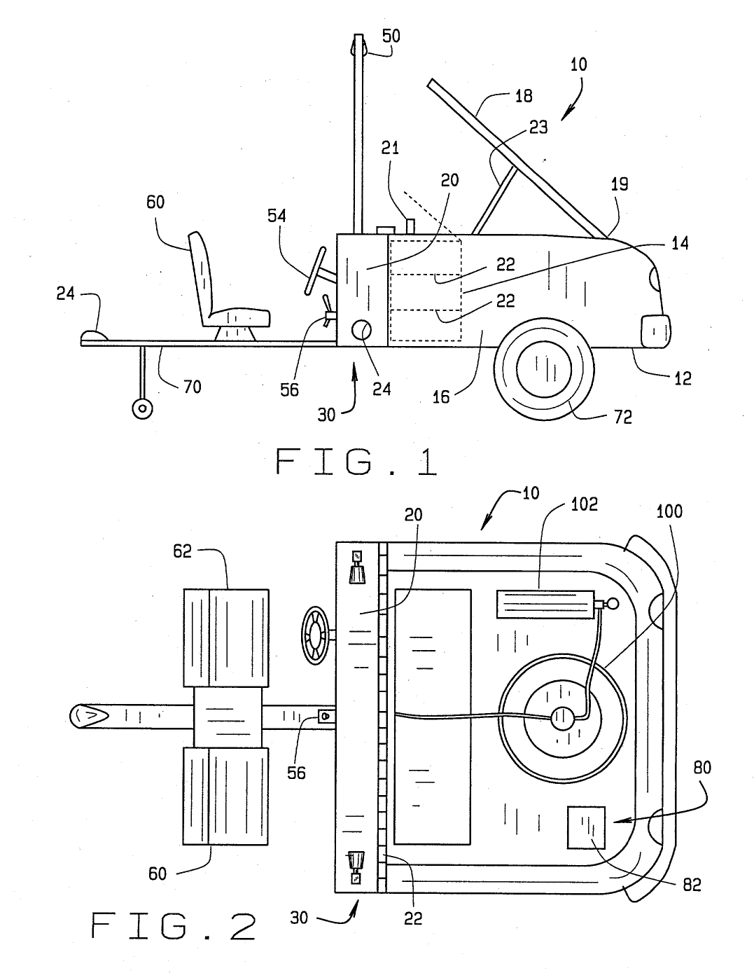

Referring to FIGS. 1 and 2, a combination portable barbecue pit and front-end assembly of a motor vehicle is illustrated generally at 10. The front-end assembly is indicated at 12. The barbecue pit assembly is indicated at 14. The barbecue pit assembly 14 is located in a barbeque pit compartment 16 where the engine would normally be located. Alternatively, a rear engine type automobile could be implemented by placing the pit assembly 14 in the front trunk area. While it is preferred that an automobile front-end assembly be converted from a previously in-use automobile, a pseudo vehicle front-end assembly could be specially fabricated for use with the present invention without departing from the scope of the present invention. Additionally, while it is preferred that the present invention be 1:1 scale, a reduced scale version of an automobile could be implemented without departing from the scope of the present invention.

The front-end assembly 12 further comprises a hood 18 that covers the barbeque pit compartment 16. The hood 18 is attached to the front-end assembly 12 with a pair of hinges 19 and retained in the lowered position with two hood pins 21, such as those commonly available in auto supply stores. The hood 18 raises such that a “driver” of the barbeque pit can access the underside of the hood 18. The hood 18 is maintained in the raised position by a rod 23. Alternatively, the rod 23 could be eliminated and replaced with spring-loaded hinges that maintain the hood 18 in the raised position.

The barbecue pit 14 is preferably made from 1/8″ thick sheet steel and has two horizontal rows of expanded metal grating 22 for supporting charcoal and food items to be cooked. Alternatively, a gas supply may be used. Optionally, insulation may be placed around the barbeque pit 14 in order to protect other portions of the grill 10 from heat. The front-end assembly 12 may further comprises a large rubber tub 100 for holding bulk beverages, such as a keg of beer, and positioned near a CO₂ supply 102 to pressurize the bulk container. Additionally, a battery 82 may be supplied to provide power for electrical items, described below. Alternatively, the battery may be attached to an AC to DC converter in order to provide power from an outside source.

Bucket seats 60 and 62 are provided for a barbequer and an assistant to be seated while barbequeing. The seats 60, 62 are supported from a length of square steel tubing 70. Attached to the end of the tubing 70 is trailer hitch 74 that allows that allows the grill 10 to be transported by towing it with another vehicle.

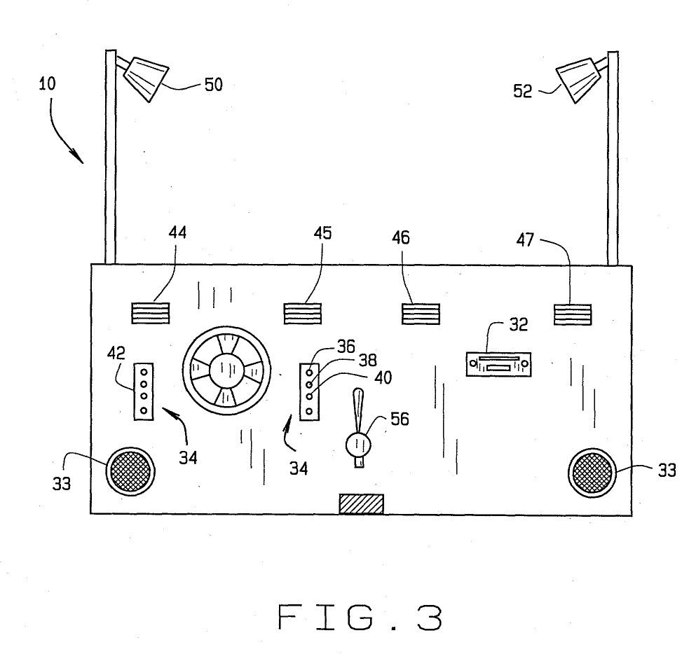

Referring to FIG. 3, a dash replica 30 is provided to imitate the appearance of a car dash. The top of the dash assembly is preferable flat and can be used as a shelf for the barbequer to place items such as cooking utensils, foods, spices, etc. The dash replica is designed to further accommodate an audio entertainment device 32, such a radio, CD player or other recorded music player, attached to speakers 33. Switches 34 control optional turn signals 36, headlights 38, a blower motor 40 and an air conditioning system 42. The switches may or may not actually be functional depending on the options included with the barbeque grill. Vents 44, 45, 46, 47 are provided to blow air to cool the barbequer when the weather is hot when the optional blower motor and/or air conditioner is included. Lights 50, 52 are provided on each side of the vehicle to provide the capability of cooking at night or when visibility is low. A non-functioning steering wheel 54 is also provided. The dash replica 30 may further comprise a storage compartment that may be utilized by removing the top to access the compartment. Preferably, the top is attached with a hinge 22. Finally, the dash replica 30 may comprises a tapper 56 for dispensing beverages contained in the rubber tub 100.

I claim:

1. A barbeque grill comprising:
a vehicle front-end assembly defining a barbeque pit compartment;
a barbeque pit mounted within the barbeque pit compartment.

2. The barbeque grill as in claim 1 further comprising a dash replica portion.

3. The barbeque grill as in claim 2 wherein the dash replica portion comprises an audio entertainment device.

4. The barbeque grill of claim 2 wherein the dash replica comprises a storage compartment.

5. The barbeque grill of claim 1 further comprises a power source and lights for illuminating an area surrounding the grill.

6. The barbeque grill of claim 1 wherein the vehicle front-end assembly is a front-end assembly converted from a previously in-use automobile.

7. The barbeque grill of claim 1 wherein the barbeque grill further comprises a trailer hitch for towing the barbeque grill behind a vehicle.

8. The barbeque grill of claim 1 wherein the barbeque pit compartment further comprises a tub for storing a bulk cold beverage container and the dash replica comprises a tapper for dispensing beverages from the bulk cold beverage container.

9. The barbeque grill of claim 3 wherein the dash replica comprises a storage compartment.

10. The barbeque grill of claim 9 further comprises a power source and lights for illuminating an area surrounding the grill.

11. The barbeque grill of claim 10 wherein the vehicle front-end assembly is a front-end assembly converted from a previously in-use automobile.

12. The barbeque grill of claim 11 wherein the barbeque grill further comprises a trailer hitch for towing the barbeque grill behind a vehicle.

13. The barbeque grill of claim 12 wherein the barbeque pit compartment further comprises a tub for storing a bulk cold beverage container and the dash replica comprises a tapper for dispensing beverages from the bulk cold beverage container.
